(19) United States
(12) Patent Application Publication
(10) Pub. No.: US 2023/0318145 A1
(43) Pub. Date: Oct. 5, 2023

(54) SOLID-STATE BATTERY

(71) Applicant: HONDA MOTOR CO., LTD., Tokyo (JP)

(72) Inventors: Takuya TANIUCHI, Saitama (JP); Toshiyuki ARIGA, Saitama (JP); Tadashi MATSUSHITA, Saitama (JP)

(21) Appl. No.: 18/181,560

(22) Filed: Mar. 10, 2023

(30) Foreign Application Priority Data
Mar. 30, 2022 (JP) 2022-056156

(51) Int. Cl. H01M 50/474

(52) U.S. Cl. CPC H01M 50/474

(57) ABSTRACT

Provided is a solid-state battery comprising: electrode laminates, each of the electrode laminates being configured with a solid electrolyte layer and a positive electrode composite layer that are sequentially laminated on a negative electrode current collector; and a positive electrode current collector sandwiched between the electrode laminates. The positive electrode composite layer is provided with a positive electrode insulating frame on an outer perimetric part thereof. When the solid-state battery is viewed from above, an outer perimetric edge of the negative electrode current collector exists inward of an outer perimetric edge of the solid electrolyte layer, and an outer perimetric edge of the positive electrode insulating frame exists at a same position as the outer perimetric edge of the solid electrolyte layer or exists outward of the outer perimetric edge of the solid electrolyte layer.

This application is based on and claims the benefit of priority from Japanese Patent Application 2022-056156, filed on 30 Mar. 2022, the content of which is incorporated herein by reference.

### BACKGROUND OF THE INVENTION

### Field of the Invention

The present invention relates to a solid-state battery.

### Related Art

Recently, research and development of a secondary battery that contributes to energy efficiency have been performed so that many people can secure access to affordable, reliable, sustainable and advanced energy.

Japanese Unexamined Patent Application, Publication No. 2020-4697 discloses an all-solid-state battery that includes: a positive electrode current collector layer, a first positive electrode active material layer laminated on a surface on one side of the positive electrode current collector layer, a second positive electrode active material layer laminated on a surface on the other side of the positive electrode current collector layer, a first solid electrolyte layer laminated on a surface on one side of the first positive electrode active material layer, a second solid electrolyte layer laminated on a surface on the other side of the second positive electrode active material layer, a first negative electrode active material layer laminated on a surface on one side of the first solid electrolyte layer, a second negative electrode active material layer laminated on a surface on the other side of the second solid electrolyte layer, a first negative electrode current collector layer laminated on a surface on one side of the first negative electrode active material layer, and a second negative electrode current collector layer laminated on a surface on the other side of the second negative electrode active material layer. At least the positive electrode current collector layer extends outward of the first negative electrode active material layer and the second negative electrode active material layer to constitute an extending portion, and an insulating resin layer is continuously provided over a surface on one side of the extending portion, side surfaces of the extending portion, and a surface on the other side of the extending portion.

Patent Document 1: Japanese Unexamined Patent

Application, Publication No. 2020-4697

### SUMMARY OF THE INVENTION

It is conceivable to apply an automatic lamination apparatus to manufacture of an all-solid-state battery. For example, positive electrode sheets, negative electrode sheets and solid electrolyte layer sheets that are set in stockers are cut in an arbitrary shape and are laminated in turn so as to reach an arbitrary number of laminated layers.

However, when the all-solid-state battery of Japanese Unexamined Patent Application, Publication No. 2020-4697 is viewed from above, the outer perimetric edge of the solid electrolyte layer does not exist outward of the outer perimetric edge of the negative electrode current collector layer in the direction in which the extending portion extends. Therefore, there is a possibility that, when θ-shift of the negative electrode current collector layer occurs, a short circuit occurs. Further, since a positive electrode insulating frame is not provided on the outer perimetric part of the positive electrode active material layer, the strength of the all-solid-state battery decreases.

An object of the present invention is to provide an all-solid-state battery in which occurrence of a short circuit can be prevented or reduced, and the strength of which can be improved.

An aspect of the present invention is directed to a solid-state battery including: electrode laminates, each of the electrode laminates being configured with a solid electrolyte layer and a positive electrode composite layer that are sequentially laminated on a negative electrode current collector; and a positive electrode current collector sandwiched between the electrode laminates. The positive electrode composite layer is provided with a positive electrode insulating frame on an outer perimetric part thereof. When the solid-state battery is viewed from above, an outer perimetric edge of the negative electrode current collector exists inward of an outer perimetric edge of the solid electrolyte layer, and an outer perimetric edge of the positive electrode insulating frame exists at a same position as the outer perimetric edge of the solid electrolyte layer or exists outward of the outer perimetric edge of the solid electrolyte layer.

In the above solid-state battery, a positive electrode tab may extend from the positive electrode current collector, a negative electrode tab may extend from the negative electrode current collector, a side on which the positive electrode tab extends may be opposite to a side on which the negative electrode tab extends, and when the solid-state battery is viewed from above, the outer perimetric edge of the positive electrode insulating frame on the side on which the positive electrode tab extends may exist outward of the outer perimetric edge of the solid electrolyte layer.

The solid electrolyte layer may include an extending portion extending on the side on which the negative electrode tab extends.

Each of the electrode laminates may be configured with a negative electrode composite layer, the solid electrolyte layer and the positive electrode composite layer that are sequentially laminated on the negative electrode current collector.

The negative electrode composite layer may be provided with a negative electrode insulating frame on an outer perimetric part thereof, and when the solid-state battery is viewed from above, an outer perimetric edge of the negative electrode insulating frame on the side on which the negative electrode tab extends may exist outward of the outer perimetric edge of the negative electrode current collector.

The negative electrode insulating frame may include material capable of expansion and contraction.

Each of the electrode laminates may include an intermediate layer formed between the negative electrode composite layer and the solid electrolyte layer, and when the solid-state battery is viewed from above, an outer perimetric edge of the intermediate layer may exist at a same position as the outer perimetric edge of the negative electrode insulating frame or may exist inward of the outer perimetric edge of the negative electrode insulating frame.

Strength of an area of the solid electrolyte layer facing the negative electrode composite layer and/or the positive electrode composite layer may be higher than strength of an area not facing the negative electrode composite layer or the positive electrode composite layer.

Another aspect of the present invention is directed to a solid-state battery including: electrode laminates, each of the electrode laminates being configured with a positive electrode composite layer, a solid electrolyte layer and a negative electrode composite layer that are sequentially laminated on a positive electrode current collector; and a negative electrode current collector sandwiched between the electrode laminates. The negative electrode composite layer is provided with a negative electrode insulating frame on an outer perimetric part thereof. When the solid-state battery is viewed from above, an outer perimetric edge of the positive electrode current collector exists inward of an outer perimetric edge of the solid electrolyte layer, and an outer perimetric edge of the negative electrode insulating frame exists at a same position as the outer perimetric edge of the solid electrolyte layer or exists outward of the outer perimetric edge of the solid electrolyte layer.

According to the present invention, it is possible to provide an all-solid-state battery in which occurrence of a short circuit can be prevented or reduced, and the strength of which can be improved.

### BRIEF DESCRIPTION OF THE DRAWINGS

FIG. 1 is a top view showing an example of an all-solid-state battery of an embodiment;

FIGS. 2A and 2B are cross-sectional views showing the all-solid-state battery of FIG. 1;

FIGS. 3A to 3G are schematic diagrams (1) illustrating a manufacturing method for the all-solid-state battery of FIG. 1;

FIGS. 4A to 4F are schematic diagrams (2) illustrating a manufacturing method for the all-solid-state battery of FIG. 1; and

FIG. 5 is a schematic diagram illustrating a case where the all-solid-state battery of FIG. 1 is manufactured using an automatic lamination apparatus.

### DETAILED DESCRIPTION OF THE INVENTION

An embodiment of the present invention will be described below with reference to drawings.

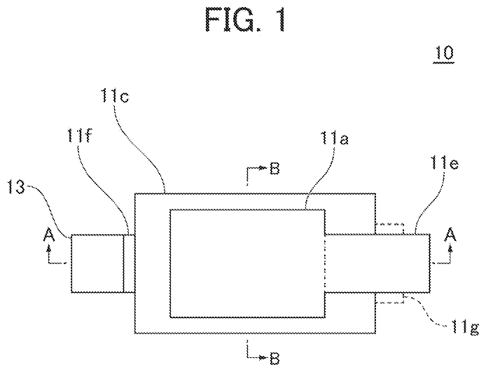

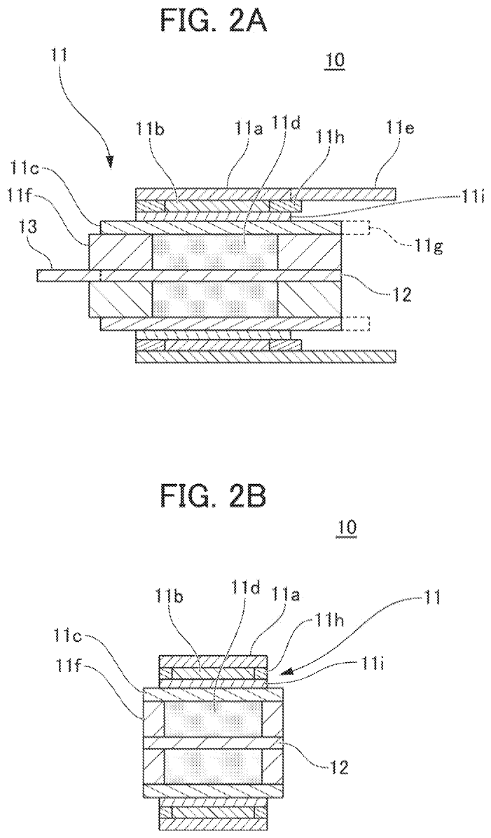

An example of a solid-state battery of the present embodiment is shown in FIG. 1 and FIGS. 2A and 2B. FIGS. 2A and 2B are cross-sectional views in an A-A direction and a B-B direction in FIG. 1, respectively.

In a solid-state battery 10, a positive electrode current collector 12 is sandwiched by electrode laminates 11, each of the electrode laminates 11 being configured with a negative electrode composite layer 11b, a solid electrolyte layer 11C and a positive electrode composite layer 11d that are sequentially laminated on a negative electrode current collector 11a. In the solid-state battery 10, negative tabs 11e extend from the negative electrode current collectors 11a, respectively. Further, the positive electrode composite layers 11d are provided with positive electrode insulating frames 11f on their outer perimetric parts, respectively. When the solid-state battery 10 is viewed from above, the outer perimetric edges of the negative electrode current collectors 11a exist inward of the outer perimetric edges of the solid electrolyte layers 11c, respectively. Therefore, even if θ-shift of any of the negative electrode current collectors 11a occurs, occurrence of a short circuit is prevented or reduced. When the solid-state battery 10 is viewed from above, the outer perimetric edges of the positive electrode insulating frames 11f exist at the same positions as the outer perimetric edges of the solid electrolyte layers 11c or outward of the outer perimetric edges of the solid electrolyte layers 11c, respectively. Therefore, the strength of the solid-state battery 10 is improved.

In each of the electrode laminates 11, adjacent layers among the layers of the negative electrode current collector 11a, the negative electrode composite layer 11b, the solid electrolyte layer 11c and the positive electrode composite layer 11d may be in contact with each other, or have another layer therebetween.

The material constituting the positive electrode insulating frames 11f is not especially limited. For example, an insulating oxide such as alumina, resin such as polyvinylidene fluoride (PVDF), and rubber such as styrene butadiene rubber (SBR) are exemplified.

Each of the electrode laminates 11 is only required to have the negative electrode composite layer 11b, the solid electrolyte layer 11c and the positive electrode composite layer 11d that are sequentially laminated on the negative electrode current collector 11a, and may have a plurality of positive electrodes and/or negative electrodes. As a laminated structure of the electrode laminate 11 having a plurality of positive electrodes and/or negative electrodes, for example, “positive electrode current collector 12/positive electrode composite layer 11d/solid electrolyte layer 11c/negative electrode composite layer 11b/negative electrode current collector 11a/negative electrode current collector 11a/negative electrode composite layer 11b/solid electrolyte layer 11c/positive electrode composite layer 11d” or the like is exemplified.

The electrode laminates 11 sandwiching the positive electrode current collector 12 may be the same or may be different.

Furthermore, in the solid-state battery 10, the positive electrode, the negative electrode and members related to the electrodes may be reversely arranged.

In the solid-state battery 10, a positive electrode tab 13 extends from the positive electrode current collector 12, and the side on which the positive electrode tab 13 extends is opposite to the side on which the negative tabs 11e extend. When the solid-state battery 10 is viewed from above, the outer perimetric edges of the positive electrode insulating frames 11f on the side on which the positive electrode tab 13 extends exist outward of the outer perimetric edges of the solid electrolyte layers 11c, respectively. That is, the positive electrode insulating frames 11f are also formed on parts of the positive electrode tab 13 on the positive electrode current collector 12 side. Therefore, occurrence of a short circuit is prevented or reduced, and the strength of the solid-state battery 10 is improved.

When the solid-state battery 10 is viewed from above, the outer perimetric edges of the positive electrode insulating frames 11f on the side on which the positive electrode tab 13 extends may exist at the same position as the outer perimetric edges of the solid electrolyte layers 11c.

The solid electrolyte layers 11c may include extending portions 11g extending on the side on which the negative tabs 11e extend, respectively, as indicated by broken lines in FIGS. 1 and 2A. Thereby, even if a load is applied to any of the negative tabs 11e, the negative tab 11e is inhibited from coming into contact with the positive electrode tab 13.

The side on which the positive electrode tab 13 extends may be the same as the side on which the negative tabs 11e extend.

The negative electrode composite layers 11b are provided with negative electrode insulating frames 11h on their outer perimetric parts, respectively. When the solid-state battery 10 is viewed from above, the outer perimetric edges of the negative electrode insulating frames 11h on the side on which the negative tabs 11e extend exist outward of the outer perimetric edges of the negative electrode current collectors 11a, respectively. That is, the negative electrode insulating frames 11h are also formed on parts of the negative tabs 11e on the negative electrode current collector 11a side, respectively. Therefore, occurrence of a short circuit is prevented or reduced, and the strength of the solid-state battery 10 is improved.

The material constituting the negative electrode insulating frames 11h is not especially limited. For example, an insulating oxide such as alumina, resin such as polyvinylidene fluoride (PVDF), and rubber such as styrene butadiene rubber (SBR) are exemplified.

The negative electrode insulating frames 11h may include material capable of expansion and contraction. Thereby, expansion and contraction of the negative electrode composite layers 11b accompanying charging/discharging of the solid-state battery 10 are absorbed.

The material capable of expansion and contraction is not especially limited. For example, rubber such as fluorinated rubber, silicone rubber and isoprene rubber are exemplified.

In each of the electrode laminates 11, an intermediate layer 11i is further formed between the negative electrode composite layer 11b and the solid electrolyte layer 11c. When the solid-state battery 10 is viewed from above, the outer perimetric edges of the intermediate layers 11i exist at the same positions as the outer perimetric edges of the negative electrode insulating frames 11h or inward of the outer perimetric edges of the negative electrode insulating frames 11h, respectively. Here, the intermediate layers 11i are formed on the negative electrode current collectors 11a, respectively. Therefore, the interfaces of the negative electrode composite layers 11b and the solid electrolyte layers 11c are stabilized.

The intermediate layers 11i have a function of, when the solid-state battery 10 is a lithium metal secondary battery, causing Li metal to be equally precipitated. Here, the lithium metal secondary battery may be a battery without the negative electrode composite layers 11b, that is, an anode-free battery. In this case, lithium metal layers as the negative electrode composite layers 11b are formed after initial charging/discharging. Therefore, when the solid-state battery 10 is not a lithium metal secondary battery, the intermediate layers 11i can be omitted.

The material constituting the intermediate layers 11i is not especially limited. For example, carbon or the like that includes metal that can be alloyed with Li (for example, Ag) is exemplified.

The strength of an area of each of the solid electrolyte layers 11c facing the negative electrode composite layer 11b and/or the positive electrode composite layer 11d is higher than the strength of an area not facing the negative electrode composite layer 11b or the positive electrode composite layer 11d. Therefore, the strength of the solid-state battery 10 is improved. The strength of the solid electrolyte layers 11c can be controlled by mixture for the solid electrolyte layers 11c (for example, the solid electrolyte content).

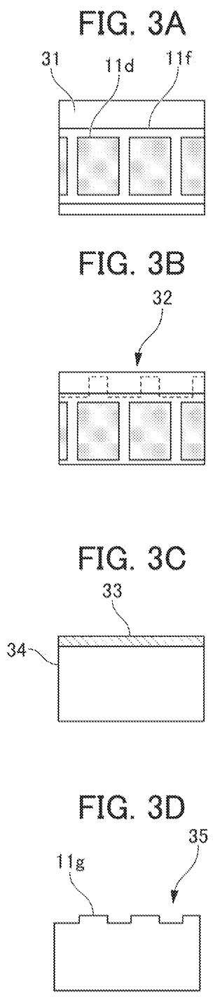

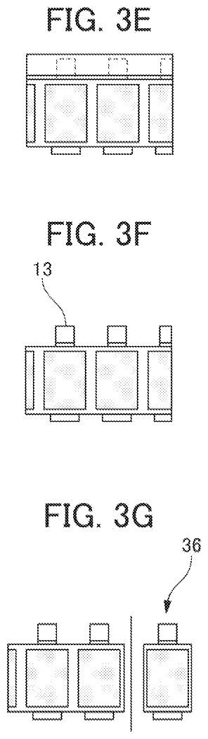

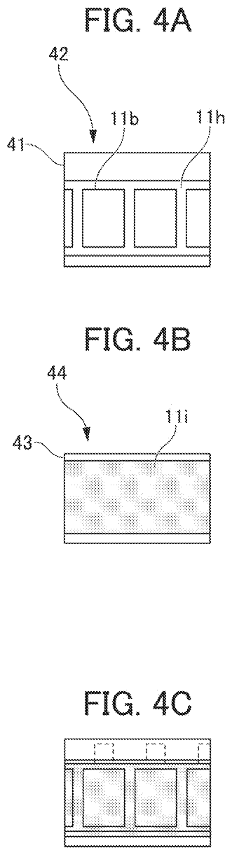

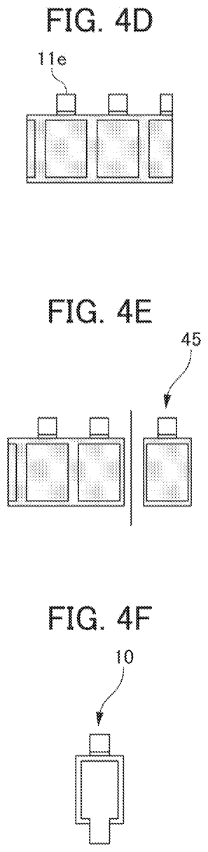

A method for manufacturing the solid-state battery 10 will be described, using FIGS. 3A to 3G and FIGS. 4A to 4F.

After the positive electrode composite layers 11d and the positive electrode insulating frame 11f are formed on a positive electrode current collector 31 (see FIG. 3A), margins are cut off to obtain a positive electrode sheet 32 (see FIG. 3B). Next, after non-woven fabric 33 is impregnated with a solid electrolyte 34 (see FIG. 3C), margins are cut off to form the extending portions 11g, and a solid electrolyte layer sheet 35 is obtained (see FIG. 3D). Next, the positive electrode sheet 32 and the solid electrolyte layer sheet 35 are overlapped with each other and then roll-pressed (see FIG. 3E). Next, after the positive electrode tabs 13 are formed by cutting off margins (see FIG. 3F), a part with a size corresponding to the solid-state battery 10 is cut out to obtain a positive electrode-solid electrolyte layer laminate 36 (see FIG. 3G).

Meanwhile, the negative electrode composite layers 11b and the negative electrode insulating frame 11h are formed on a negative electrode current collector 41 to obtain a negative electrode sheet 42 (see FIG. 4A). Next, the intermediate layer 11i is formed on a base material 43 to obtain an intermediate layer transfer sheet 44 (see FIG. 4B). Next, the intermediate layer 11i is transferred to the negative electrode sheet 42 using the intermediate layer transfer sheet 44 and then roll-pressed (see FIG. 4C). Next, after the negative tabs 11e are formed by cutting off margins (see FIG. 4D), a part with a size corresponding to the solid-state battery 10 is cut out to obtain a negative electrode-intermediate layer laminate 45 (see FIG. 4E). Next, the positive electrode-solid electrolyte layer laminate 36 and the negative electrode-intermediate layer laminate 45 are overlapped with each other and then roll-pressed to obtain the solid-state battery 10 (see FIG. 4F).

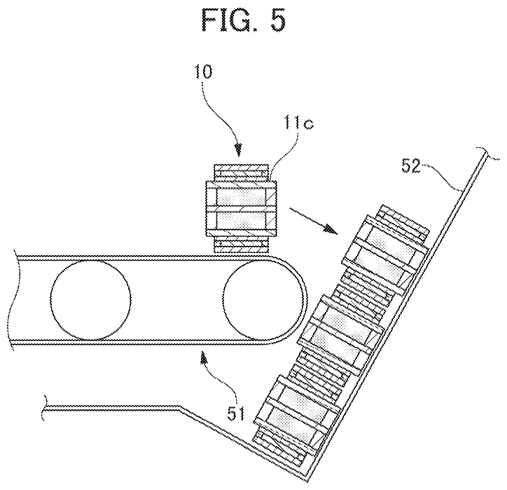

The solid-state battery 10 may be manufactured using an automatic lamination apparatus. In this case, as shown in FIG. 5, the manufactured solid-state battery 10 is carried by a belt conveyor 51 and discharged onto a tray 52. At this time, the solid-state battery 10 is positioned with the solid electrolyte layer 11c.

A description will be made below on a case where the solid-state battery of the present embodiment is an all-solid-state lithium secondary battery.

The positive electrode current collector is not especially limited. For example, aluminum foil is exemplified.

The positive electrode composite layers include positive electrode active material and may further include a solid electrolyte, a conductive agent, a binder and the like.

The positive electrode active material is not especially limited if lithium ions can be occluded and released. For example, LiCoO₂, Li (Ni_{5/10}Co_{s/20}Mn_{3/10})O₂, Li (Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide and sulfur are exemplified.

The solid electrolyte constituting the solid electrolyte layers may be any material that is capable of conducting lithium ions. For example, an oxide electrolyte, and a sulfide electrolyte are exemplified.

The negative electrode composite layers include negative electrode active material and may further include a solid electrolyte, a conductive agent, a binder and the like.

The negative electrode active material is not especially limited if lithium ions can be occluded and released. For example, metallic lithium, lithium alloy, metal oxide, metal sulfide, metal nitride, Si, SiO, and carbon material are exemplified. As the carbon material, for example, artificial graphite, natural graphite, hard carbon, and soft carbon are exemplified.

The negative electrode current collector is not especially limited. For example, copper foil is exemplified.

An embodiment of the present invention has been described above. The present invention, however, is not limited to the above embodiment. The above embodiment may be appropriately changed within the spirit of the present invention.

### EXPLANATION OF REFERENCE NUMERALS

10: Solid-state battery
11: Electrode laminate
11a: Negative electrode current collector
11b: Negative electrode composite layer
11c: Solid electrolyte layer
11d: Positive electrode composite layer
11e: Negative tab
11f: Positive electrode insulating frame
11g: Extending portion
11h: Negative electrode insulating frame
11i: Intermediate layer
12: Positive electrode current collector
13: Positive electrode tab
31: Positive electrode current collector
32: Positive electrode sheet
33: Non-woven fabric
34: Solid electrolyte
35: Solid electrolyte layer sheet
36: Positive electrode-solid electrolyte layer laminate
41: Negative electrode current collector
42: Negative electrode sheet
43: Base material
44: Intermediate layer transfer sheet
45: Negative electrode-intermediate layer laminate
51: Belt conveyor
52: Tray

What is claimed is:

1. A solid-state battery comprising:
electrode laminates, each of the electrode laminates being configured with a solid electrolyte layer and a positive electrode composite layer that are sequentially laminated on a negative electrode current collector; and
a positive electrode current collector sandwiched between the electrode laminates, wherein
the positive electrode composite layer is provided with a positive electrode insulating frame on an outer perimetric part thereof; and
when the solid-state battery is viewed from above, an outer perimetric edge of the negative electrode current collector exists inward of an outer perimetric edge of the solid electrolyte layer, and an outer perimetric edge of the positive electrode insulating frame exists at a same position as the outer perimetric edge of the solid electrolyte layer or exists outward of the outer perimetric edge of the solid electrolyte layer.

2. The solid-state battery according to claim 1, wherein
a positive electrode tab extends from the positive electrode current collector,
a negative electrode tab extends from the negative electrode current collector,
a side on which the positive electrode tab extends is opposite to a side on which the negative electrode tab extends, and
when the solid-state battery is viewed from above, the outer perimetric edge of the positive electrode insulating frame on the side on which the positive electrode tab extends exists outward of the outer perimetric edge of the solid electrolyte layer.

3. The solid-state battery according to claim 2, wherein
the solid electrolyte layer comprises an extending portion extending on the side on which the negative electrode tab extends.

4. The solid-state battery according to claim 1, wherein
each of the electrode laminates is configured with a negative electrode composite layer, the solid electrolyte layer and the positive electrode composite layer that are sequentially laminated on the negative electrode current collector.

5. The solid-state battery according to claim 4, wherein
the negative electrode composite layer is provided with a negative electrode insulating frame on an outer perimetric part thereof; and
when the solid-state battery is viewed from above, an outer perimetric edge of the negative electrode insulating frame on the side on which the negative electrode tab extends exists outward of the outer perimetric edge of the negative electrode current collector.

6. The solid-state battery according to claim 5, wherein the negative electrode insulating frame includes material capable of expansion and contraction.

7. The solid-state battery according to claim 5, wherein
each of the electrode laminates comprises an intermediate layer formed between the negative electrode composite layer and the solid electrolyte layer; and
when the solid-state battery is viewed from above, an outer perimetric edge of the intermediate layer exists at a same position as the outer perimetric edge of the negative electrode insulating frame or exists inward of the outer perimetric edge of the negative electrode insulating frame.

8. The solid-state battery according to claim 4, wherein
strength of an area of the solid electrolyte layer facing the negative electrode composite layer and/or the positive electrode composite layer is higher than strength of an area not facing the negative electrode composite layer or the positive electrode composite layer.

9. A solid-state battery comprising:
electrode laminates, each of the electrode laminates being configured with a positive electrode composite layer, a solid electrolyte layer and a negative electrode composite layer that are sequentially laminated on a positive electrode current collector; and
a negative electrode current collector sandwiched between the electrode laminates, wherein
the negative electrode composite layer is provided with a negative electrode insulating frame on an outer perimetric part thereof; and
when the solid-state battery is viewed from above, an outer perimetric edge of the positive electrode current collector exists inward of an outer perimetric edge of the solid electrolyte layer, and an outer perimetric edge of the negative electrode insulating frame exists at a same position as the outer perimetric edge of the solid electrolyte layer or exists outward of the outer perimetric edge of the solid electrolyte layer.
